(19) United States
(12) Patent Application Publication
(10) Pub. No.: US 2009/0068080 A1
(43) Pub. Date: Mar. 12, 2009

(54) Method of Making Active Materials For Use in Secondary Electrochemical Cells

(75) Inventor: Titus Faulkner, Las Vegas, NV (US)

Correspondence Address: VALENCE TECHNOLOGY, INC., 1889 E. MAULE AVENUE, SUITE A, LAS VEGAS, NV, 89119, US

(73) Assignee: Valence Technology, Inc., Las Vegas, NV (US)

(21) Appl. No.: 11/850,792

(22) Filed: Sep. 6, 2007

(51) Int. Cl. C01B 25/30

(52) U.S. Cl. 423/306

(57) ABSTRACT

The present invention provides for the two step preparation of lithium vanadium phosphate by pre-treatment of a mixture of precursor materials via high pressure at relatively low temperatures in water (hydrothermal pretreatment) and then calcining such hydrothermally pretreated precursors at relatively high temperatures for a period of time sufficient to produce lithium vanadium phosphate. The lithium vanadium phosphate so produced finds use in producing electrodes for electrochemical cells.

### FIELD OF THE INVENTION

The present invention relates to a process for the preparation of lithium vanadium phosphate by hydrothermal pretreatment of the precursors and then calcining said hydrothermally pretreated precursors at a temperature and for a time to produce the lithium vanadium phosphate. The lithium vanadium phosphate so produced is electroactive and is useful in making electrodes for electrochemical cells.

### BACKGROUND OF THE INVENTION

A battery pack consists of one or more electrochemical cells or batteries, wherein each cell typically includes a positive electrode, a negative electrode, and an electrolyte or other material for facilitating movement of ionic charge carriers between the negative electrode and positive electrode. As the cell is charged, cations migrate from the positive electrode to the electrolyte and, concurrently, from the electrolyte to the negative electrode. During discharge, cations migrate from the negative electrode to the electrolyte and, concurrently, from the electrolyte to the positive electrode.

By way of example and generally speaking, lithium ion batteries are prepared from one or more lithium ion electrochemical cells containing electrochemically active (electroactive) materials. Such cells typically include, at least, a negative electrode, a positive electrode, and an electrolyte for facilitating movement of ionic charge carriers between the negative and positive electrode. As the cell is charged, lithium ions are transferred from the positive electrode to the electrolyte and, concurrently from the electrolyte to the negative electrode. During discharge, the lithium ions are transferred from the negative electrode to the electrolyte and, concurrently from the electrolyte back to the positive electrode. Thus with each charge/discharge cycle the lithium ions are transported between the electrodes. Such lithium ion batteries are called rechargeable lithium ion batteries or rocking chair batteries.

The electrodes of such batteries generally include an electroactive material having a crystal lattice structure or framework from which ions, such as lithium ions, can be extracted and subsequently reinserted and/or from which ions such as lithium ions can be inserted or intercalated and subsequently extracted. Recently a class of transition metal phosphates and mixed metal phosphates have been developed, which have such a crystal lattice structure. These transition metal phosphates are insertion based compounds and allow great flexibility in the design of lithium ion batteries.

A class of such materials is disclosed in U.S. Pat. No. 6,528,033 B1 (Barker et al.). The compounds therein are of the general formula LiₐMI_{b}MII_{c}(PO₄)_{d} wherein MI and MII are the same or different. MI is a metal selected from the group consisting of Fe, Co, Ni, Mn, Cu, V, Sn, Cr and mixtures thereof. MII is optionally present, but when present is a metal selected from the group consisting of Mg, Ca, Zn, Sr, Pb, Cd, Sn, Ba, Be and mixtures thereof. More specific examples of such compounds include compounds wherein MI is vanadium and more specifically includes Li₃V₂(PO₄)₃.

Although these compounds find use as electrochemically active materials these materials are not always economical to produce in an efficient manner. Thus it would be beneficial to have a process for preparing such intercalation materials more economically and efficiently. The inventor of the present invention has now found that hydrothermal pretreatment of precursors can produce more efficiently and economically.

### SUMMARY OF THE INVENTION

The present invention provides for the two step preparation of lithium vanadium phosphate by pre-treatment of a mixture of precursor materials via high pressure at relatively low temperatures in water (hydrothermal pretreatment) and then calcining such hydrothermally pretreated precursors at relatively high temperatures for a period of time sufficient to produce lithium vanadium phosphate. The lithium vanadium phosphate so produced finds use in producing electrodes for electrochemical cells.

### BRIEF DESCRIPTION OF THE DRAWINGS

FIG. 1 shows an X-ray powder pattern for LVP synthesized by calcining the hydrothermally treated precursor.

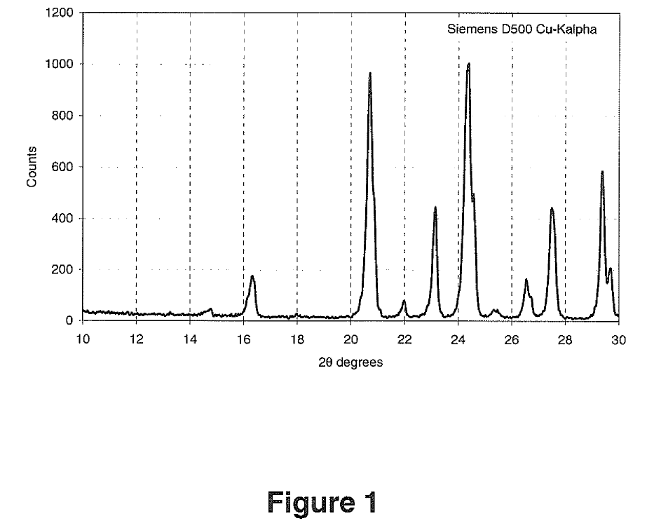

### DETAILED DESCRIPTION OF THE INVENTION

Specific benefits and embodiments of the present invention are apparent from the detailed description set forth herein below. It should be understood, however, that the detailed description and specific examples, while indicating embodiments among those preferred, are intended for purposes of illustration only and are not intended to limit the scope of the invention.

The following is a list of some of the definitions of various terms used herein:

As used herein “battery” refers to a device comprising one or more electrochemical cells for the production of electricity. Each electrochemical cell comprises an anode, a cathode and an electrolyte.

As used herein the terms “anode” and “cathode” refer to the electrodes at which oxidation and reduction occur, respectively, during battery discharge. During charging of the battery, the sites of oxidation and reduction are reversed.

As used herein the terms “nominal formula” or “nominal general formula” refer to the fact that the relative proportion of atomic species may vary slightly on the order of 2 percent to 5 percent, or more typically, 1 percent to 3 percent.

As used herein the words “preferred” and “preferably” refer to embodiments of the invention that afford certain benefits under certain circumstances. Further the recitation of one or more preferred embodiments are not useful and is not intended to exclude other embodiments from the scope of the invention.

As used herein the term “Tavorite-like phase” means a phase with structure similar to the mineral Tavorite, which has triclinic space group P1 or P 1̅.

Metal phosphates, and mixed metal phosphates and in particular lithiated metal and mixed metal phosphates have recently been introduced as electrode active materials for ion batteries and in particular lithium ion batteries. These metal phosphates and mixed metal phosphates are insertion based compounds. What is meant by insertion is that such materials have a crystal lattice structure or framework from which ions, and in particular lithium ions, can be extracted and subsequently reinserted and/or permit ions to be inserted and subsequently extracted.

The transition metal phosphates allow for great flexibility in the design of batteries, especially lithium ion batteries. Simply by changing the identity of the transition metal allows for regulation of voltage and specific capacity of the active materials. Examples of such transition metal phosphate cathode materials include such compounds of the nominal general formulae LiFePO₄, Li₃V₂(PO₄)₃ and LiFe₁₋ₓMgₓPO₄ as disclosed in U.S. Pat. No. 6,528,033 B1 (Barker et al, hereinafter referred to as the '033 patent) issued Mar. 4, 2003.

A class of compounds having the nominal general formula Li₃V₂(P0₄)₃ (lithium vanadium phosphate or LVP) are disclosed in U.S. Pat. No. 6,528,033 B1. It is disclosed therein that LVP can be prepared by ball milling V₂O₅, Li₂CO₃, (NH₄)₂HPO₄ and carbon, and then pelletizing the resulting powder. The pellet is then heated to 300° C. to remove the NH₃. The pellet is then powderized and repelletized. The new pellet is then heated at 850° C. for 8 hours to produce the desired electrochemically active product.

It has been found that when making lithium vanadium phosphate by the method of the '033 patent that problems result from the dry ball mixing method. The dry ball-mill mixing method on a larger production scale sometimes results in an incomplete reaction of the starting materials. When the incomplete reaction occurs and the product so produced is used in a cell it produces a cell with poor cycle performance. The method on a large scale also resulted in poor reproducibility of the product formed.

Previous methods for producing lithium vanadium phosphate utilized insoluble vanadium compounds either mixed in the dry state or mixed in aqueous solution with other precursors that may or may not have been soluble. Unless the dry mixing method was done with very high shear for a long period of time, it tended to leave traces of precursor in the final product. Both of these mixing methods required that the insoluble vanadium precursor be milled to a small particle size in order to overcome diffusion limitations during synthesis. Calcination of the precursor mix using insoluble vanadium tended to require at least 8 hours at 900° C. to get complete conversion.

Previous methods of producing lithium vanadium phosphate made from lithium dihydrogen phosphate and vanadium oxide via high temperature calcinations required fine particle size particles and extensive mixing in order to enable complete conversion of the precursors to lithium vanadium phosphate. Particle size reduction and intensive mixing added cost to the process and may have reduced the powder density of the lithium vanadium phosphate but the alternative was potential vanadium poisoning of batteries using the lithium vanadium phosphate so produced. In a typical mix, it was observed that 30% of the initial vanadium oxide is unreacted up to calcinations temperatures of about 700° C.

It has now surprisingly been found that lithium vanadium phosphate can be prepared in a beneficial manner. The present invention is beneficial over previously disclosed processes in that it reduces mixing time, and reduces costs by using less expensive precursors and results in improved performance of the lithium vanadium phosphate as a lithium-ion cathode material.

One embodiment of the invention involves the hydrothermal pretreatment of a mixture of precursor materials (including a vanadium oxide, a source of lithium ion and a source of phosphate ion) via high pressure at relatively low temperatures and then calcining (heating) the hydrothermally treated precursors at relatively high temperatures for a time sufficient to produce lithium vanadium phosphate.

The vanadium oxide can be V₂O₃, V₂O₅, NH₄VO₃ and the like. The source of lithium ion can be Li₂CO₃ (lithium carbonate), LHP (lithium dihydrogen phosphate) LiOH.H₂O and the like. The source of phosphate ion can be LHP, H₃PO₄, NH₃H₂PO₄, (NH₃)₂HPO₄ and the like. It would be understood by one skilled at in the art that when LHP and the like are used in the process that it is both the lithium ion source and the phosphate ion source.

The precursor materials are mixed in stoichiometric amounts in a mineralizer such as water, preferably deionized water, to produce lithium vanadium phosphate of the nominal general formula Li₃V₂(PO₄)₃. The amount of water (mineralizer) used is sufficient to cover the solids completely. The mixture is then transferred and sealed in, for instance, a Parr Model #4744 acid digestion bomb.

The bomb is then transferred to a box oven that has been pre-heated at about 250° C. This creates an autogenous (self-generating) pressure. The box is maintained at this temperature from about one hour to about 12 hours. The material is then dried prior to calcination. Alternatively, if there are no residual solubles left in the water then the material could optionally be filtered. Filtration of the material, in the event of complete hydrothermal reaction, is an economically attractive option.

The production scale equipment used for hydrothermal treatment is called an autoclave or pressure leaching vessel. It can be operated in two modes. In the batch mode, the reactants are introduced into the autoclave, which is then sealed and heated to the operating temperature for the soak time and then cooled before opening the autoclave to remove the products. In continuous mode, the reactants are pressurized and fed into the inlet end of an autoclave which is already at temperature and pressurized. The product is forced out of the continuous autoclave at the outlet end. Production scale autoclaves typically have independent control of temperature and pressure and generally, do not rely on autogenous pressure. One skilled in the art could determine the appropriate temperature and pressure for hydrothermal pretreatment. Production scale autoclaves typically are integrated with their heating systems and are not place into or removed from an oven.

The precursors that have been hydrothermally processed are then calcined at temperatures from about 800° C. to about 950° C. and preferably at 900° C. This temperature is then maintained from about 1 hour to about 16 hours and preferably for about 8 hours.

In another embodiment lithium dihydrogen phosphate, V₂O₃, and carbon are mixed in deionized water, transferred to an acid digestion bomb, and sealed in the bomb. The bomb is placed in a box and heated to about 250° C. to create an internal autogenous (self generating) pressure and maintained at this temperature to obtain conversion of the precursors to a Tavorite-like phase. The Tavorite-like phase precursor mixture is then calcined at a temperature and for a time to produce lithium vanadium phosphate.

The precursor materials are mixed in stoichiometric amounts in water (mineralizer), preferably deionized water to produce lithium vanadium phosphate of the nominal general formula Li₃V₂(PO₄)₃. For instance the LHP/V₂O₃/C are mixed in H₂O. The mixture is then transferred and sealed in for instance a bomb. Alternatively, the precursor materials are introduced into an autoclave and heated as described above. In one aspect, the source of carbon is provided by elemental carbon, preferably in particulate form such as graphites, amorphous carbon, carbon blacks and the like.

The bomb is transferred to a box oven that has been pre-heated at about 250° C. This creates an autogenous (self-generating) pressure. The box is maintained at this temperature from about one hour to about 16 hours and preferably for about 8 hours.

The precursors that have been hydrothermally pretreated are then calcined at temperatures from about 800° C. to about 950° C. and preferably at 900° C. This temperature is then maintained from about one hour to about 16 hours and preferably for about 8 hours.

In another embodiment H₃PO₄, deionized water, V₂O₃ and Li₂CO₃ are added to a bomb. The bomb is sealed and heated in a preheated oven at about 250° C. for about 3 hours. Alternatively, these precursor materials are treated in an autoclave. Carbon is then added to the hydrothermally pretreated precursor and the mixture is dried then calcined at a temperature and for a time sufficient to produce lithium vanadium phosphate.

The precursor materials are mixed stiochiometric amounts in water, preferably deionized water to produce lithium vanadium phosphate of the nominal general formula Li₃V₂(PO₄)₃. The mixture is then transferred and sealed, for instance, in a Parr Model #4744 acid digestion bomb.

The bomb is then transferred to a box oven that has been pre-heated at about 250° C. This creates an autogenous (self-generating) pressure. The box is maintained at this temperature from about one hour to about 12 hours.

Carbon sufficient to produce a residual amount from about 1% by weight to about 10% by weight is then added to the precursors that have been hydrothermally pretreated and the mixture is calcined at temperatures from about 800° C. to about 950° C. and preferably at 900° C. This temperature is then maintained from about one hour to about 16 hours and preferably for about 8 hours. The product is cooled to produce the desired lithium vanadium phosphate.

In one embodiment the reaction proceeds according to the following equations:

2LiH₂PO₄ (aqueous)+V₂O₃ (solid)→2LiVOPO₄ (tavorite)+2H₂O (hydrothermal step) (i)

2LiVOPO₄ (tavorite)+LiH₂PO₄+2C→Li₃V₂(PO₄)₃+2CO (calcining step) (ii)

The following non-limiting examples illustrate the compositions and methods of the present invention.

### EXAMPLE 1

### Preparation of LVP

Dry LVP precursor (5.00 g) consisting of a mixture of V₂O₃, LiH₂PO₄ and Super-P carbon with stoichiometry sufficient to generate a product of Li₃V₂(PO₄)₃ with 5% residual carbon was processed in a 125 ml acid digestion bomb half filled with water. The bomb was placed in a box oven preheated at 250° C. for 24 hours. The product was dried at 180° C. for 2 hours to yield 4.30 g of product whose XRD scan resembled Tavorite.

The tavorite-like product was then heated to 750° C. at a ramp rate of 10° C./minute and maintained at this temperature for 1 hour under an argon atmosphere. The product of this reaction contained a significant amount of LVP.

### EXAMPLE 2

H₃PO₄ (2.885 g, Aldrich) was added to a 45 ml bomb. Deionized water (20 ml) was added. Jet milled Li₂CO₃ (0.363 g, Pacific Lithium) was slowly added to the bomb. Then the V₂O₃ (1.471 g, Stratcor) was added. The mixture was briefly stirred and then the bomb was sealed.

The bomb was placed in a box oven which had been preheated to 250° C. and maintained at this temperature for 3 hours. Carbon (0.145 g, Super P grade from Timcal) was added to the product which was kept in its original water and then jar milled for 4 hours at approximately 15 RPM. The resulting slurry was then dried to form the hydrothermally treated precursor.

The hydrothermally treated precursor was then heated to 900° C. at a ramp rate of 5° C. per minute with an argon purge. The temperature was maintained for 8 hours to produce lithium vanadium phosphate (4.000 g).

The examples and other embodiments described herein are exemplary and not intended to be limiting in describing the full scope of compositions and methods of this invention. Equivalent changes, modifications and variations of specific embodiments, materials, compositions and methods may be made within the scope of the present invention, with substantially similar results.

What is claimed is:

1. A method for making lithium vanadium phosphate comprising mixing a vanadium oxide with a source of phosphate ion and a source of lithium ion in a mineralizer, introducing said mixture into an autoclave reactor; heating said mixture at a temperature above 100° C. and at a pressure above one atmosphere to form a hydrothermally treated precursor; and
calcining the hydrothermally treated precursor at a time and temperature sufficient to produce lithium vanadium phosphate.

2. The method according to claim 1 wherein the autoclave reactor is heated at about 100° C. to about 300° C.

3. The method according to claim 2 wherein the autoclave reactor is heated for about one hour to about 24 hours.

4. The method according to claim 1 wherein the autoclave reactor is heated at 250° C.

5. The method according to claim 4 wherein the autoclave reactor is heated for about 3 hours.

6. The method according to claim 1 wherein the vanadium oxide is V₂O₃.

7. The method according to claim 1 wherein the source of lithium ion and source of phosphate ion is LHP.

8. The method according to claim 6 wherein the source of lithium ion and source of phosphate ion is LHP.

9. The method according to claim 1 wherein the source of phosphate ion is H₃PO₄.

10. The method according to claim 6 wherein the source of phosphate ion is H₃PO₄.

11. The method according to claim 1 wherein the source of lithium ion is Li₂CO₃.

12. The method according to claim 6 wherein the source of lithium ion is Li₂CO₃.

13. The method according to claim 1 wherein the hydrothermally treated precursors are calcined at about 800° C. to about 950° C.

14. The method according to claim 13 wherein the hydrothermally treated precursors are calcined at 900° C. for about 3 to about 24 hours.

15. The method according to claim 14 wherein the hydrothermally treated precursors are heated for about 8 hours.

16. A method for making lithium vanadium phosphate comprising adding H₃PO₄, water, V₂O₃ and Li₂CO₃ to an autoclave reactor;
heating the autoclave reactor at a temperature and for a time sufficient to produce hydrothermally treated precursor;
adding carbon to the hydrothermally treated precursor to form a precursor composition; and
calcining the precursor composition at a temperature and for a time sufficient to produce lithium vanadium phosphate.

17. The method according to claim 16 wherein the autoclave reactor is heated at about 250° C. for about 1 to about 8 hours.

18. The method according to claim 17 wherein the autoclave reactor is heated for about 3 hours.

19. The method according to claim 16 wherein the precursor composition is calcined at about 750° C. to about 950° C.

20. The method according to claim 19 wherein the precursor is calcined at about 900° C. for about 8 hours.
